(19) United States
(12) Patent Application Publication
(10) Pub. No.: US 2010/0208645 A1
(43) Pub. Date: Aug. 19, 2010

(54) Method, Computer Program, Apparatus and System

(76) Inventors: Jyri Hämäläinen, Oulu (FI); Vinh Van Phan, Oulu (FI)

Correspondence Address: HARRINGTON & SMITH, 4 RESEARCH DRIVE, Suite 202, SHELTON, CT, 06484-6212, US

(21) Appl. No.: 12/680,767

(22) PCT Filed: Oct. 1, 2008
(86) PCT No.: PCT/EP08/63130

§ 371 Date: Mar. 30, 2010

(30) Foreign Application Priority Data
Oct. 2, 2007 (FI) 20075697

(51) Int. Cl. H04W 36/00; H04B 7/14

(52) U.S. Cl. 370/315; 370/331

(57) ABSTRACT

The invention is related to an apparatus including means for making a decision to change connection from one relay node to another; and means for sending a message via a source relay node to a user device, the message including radio access information on a target cell and information on a connection change, and for sending a message to the source relay node for releasing user device resources in the source relay node.

### FIELD

The invention relates to a method, computer program, apparatus and system.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

A relay-node concept has been launched to enhance cell coverage and, in particular, high-bit-rate coverage. As an example, the operation of relay nodes (RN) is in synchronization with and controlled by a root long-term evolution (LTE) enhanced node-B relay (eNBr).

There is a need to support mobility for user devices in cells utilizing relay extension. An efficient way of making handovers between sub-cells of a relay node belonging to the same or different enhanced node-B relays, and between a relay node sub-cell and its controlling eNBr has to be provided.

### BRIEF DESCRIPTION

According to an aspect of the present invention, there is provided a method as specified in claim 1.

According to another aspect of the present invention, there is provided a computer program as specified in claim 7.

According to another aspect of the present invention, there is provided an apparatus as specified in claims 8 and 15.

According to another aspect of the present invention, there is provided a system as specified in claim 22.

### LIST OF DRAWINGS

Embodiments of the present invention are described below, by way of example only, with reference to the accompanying drawings, in which

FIG. 1 illustrates an example of a communications system,

FIG. 2 shows typical handover messaging,

FIG. 3 is a flow chart,

FIG. 4 illustrates an example of handover messaging, and

FIG. 5 illustrates an example of a relay node.

### DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

The present invention is applicable to any user terminal, server, corresponding component, and/or to any communication system or any combination of different communication systems that support the use of relay extensions. The communication system may be a wireless communication system or a communication system utilizing both fixed networks and wireless networks. The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, the embodiment.

In the following, different embodiments will be described using, as an example of a system architecture whereto the embodiments may be applied, an architecture based on LTE systems without restricting the embodiment to such an architecture, however.

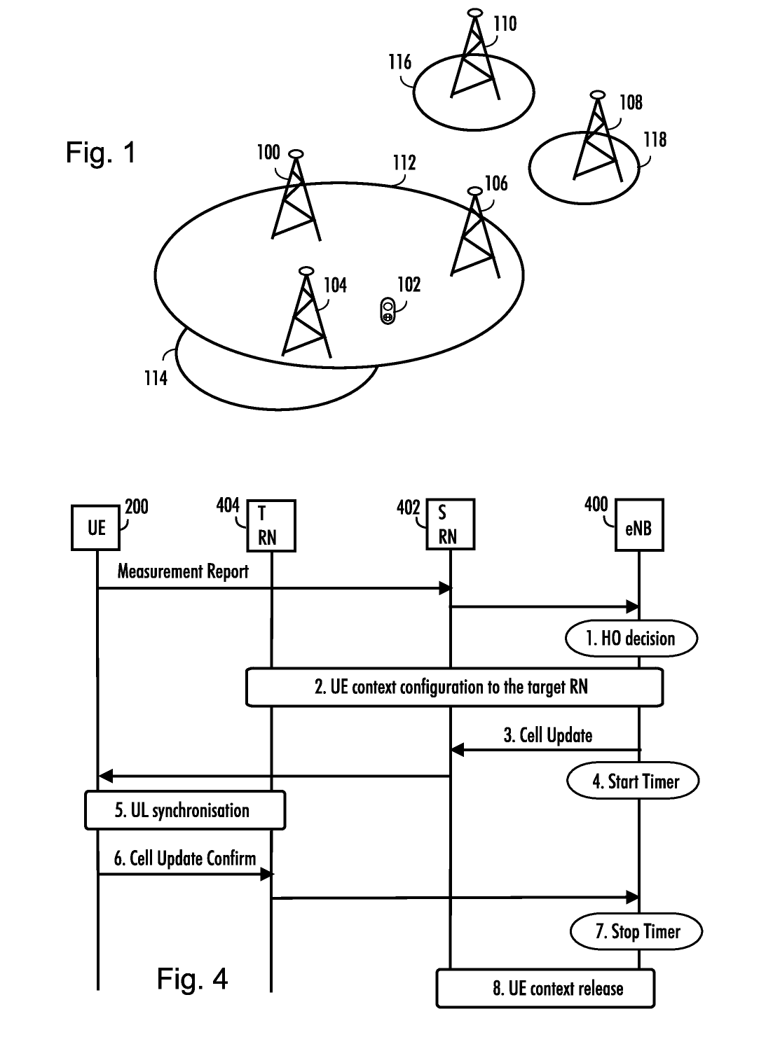

A general architecture of a communication system providing mobility and relay extensions is illustrated in FIG. 1. FIG. 1 is a simplified system architecture only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements and the protocols used in or for group communication, are irrelevant to the actual invention. Therefore, they need not be discussed in more detail here.

The communications system is a cellular radio system which comprises a long-term evolution (LTE) enhanced node-B relay (eNBr) 100 relays traffic of the communications system to other node-B relays 104-110 generating radio cells 112, 116, 118. The relay 104 generates coverage extension 114 at the cell edge. The node-B relay generates radio connections to user terminals, which may be fixed, vehicle-mounted or portable. The user terminals may refer to portable computing devices. Such computing devices include wireless mobile communication devices operating with or without a subscriber identification module (SIM), including, but not limited to, the following types of devices: mobile phone, multimedia device, personal digital assistant (PDA), handset. One user terminal 102 is shown.

The node-B relay is further connected to other network elements, such as a radio network controller and a core network. Depending on the system, the counterpart on the core network side can be a mobile services switching center (MSC), a media gateway (MGW) or a serving GPRS (general packet radio service) support node (SGSN), etc.

The embodiments are not, however, restricted to the system given as an example but a person skilled in the art may apply the solution to other communication systems provided with the necessary properties. Different radio protocols may be used in the communication systems in which embodiments of the invention are applicable. The radio protocols used are not relevant regarding the embodiments of the invention.

The communication system is also able to communicate with other networks, such as a public switched telephone network or the Internet.

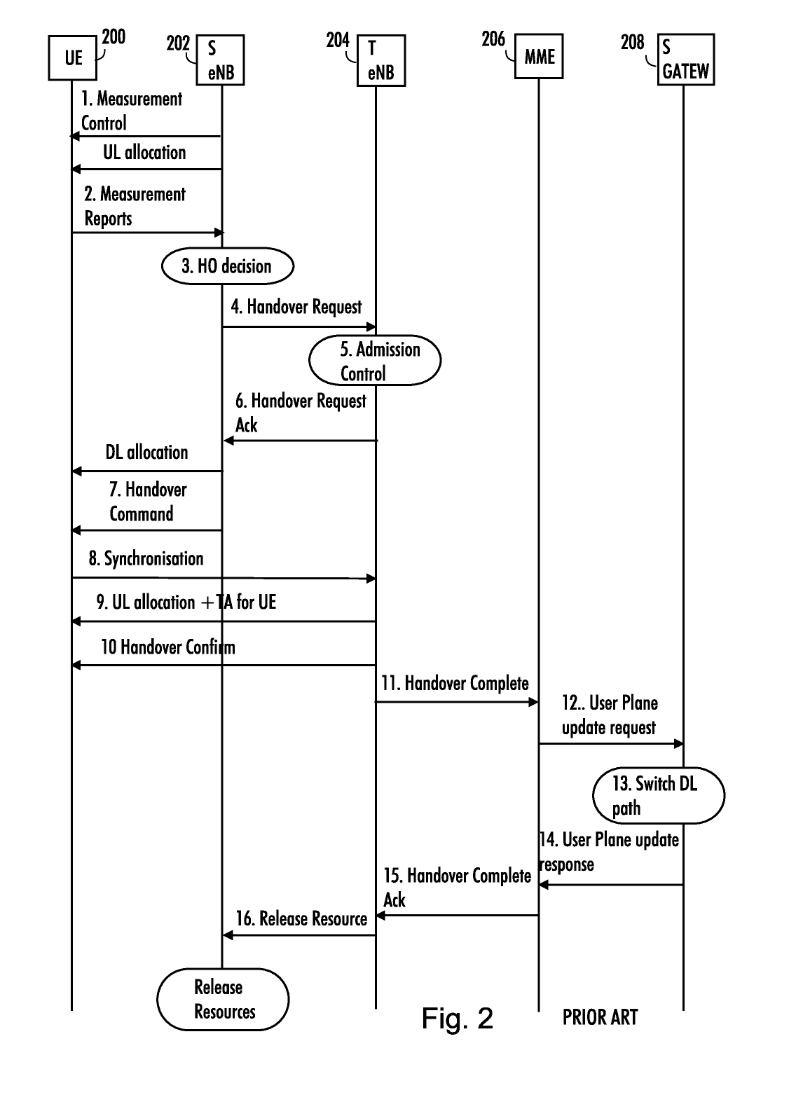

FIG. 2 shows handover messaging as it is outlined in the 3GPP TS 36.300 V8.1.0 Specification, page 44.

Measurement control is carried out by a source eNB 202. The source eNB configures the UE (user terminal, user device) measurement procedures according to the area restriction information. Measurements provided by the source eNB may assist the function controlling the user terminal's mobility.

The user terminal 200 then sends a measurement report by the rules set by system information, specification, etc.

The source eNB makes a handover decision based on the measurement report and radio resource management (RRM) information.

The source eNB issues a handover request message to the target eNB passing necessary information to prepare the handover at the target side.

Admission control may be performed by the target eNB dependent on the received System Architecture Evolution: a term used in 3GPP LTE (SAE) bearer Quality of Service information to increase the likelihood of a successful handover if the resources can be granted by the target eNB. The target eNB configures the required resources accordingly.

The target eNB sends a handover request acknowledge message to the source eNB. The message includes a transparent container to be sent to the user terminal as a part of a handover command.

The source eNB sends a handover command to the user terminal. The handover command includes a transparent container, which has been received from the target eNB 204.

After the expiry of the starting time in the handover command, the user terminal performs synchronization to the target eNB and then starts acquiring uplink (UL) timing advance.

Then the network responds with UL allocation and timing advance.

When the user terminal has successfully accessed the target cell, it sends the handover confirm message to the target eNB to indicate that the handover procedure is completed for the user terminal. The target eNB can now begin to send data to the user terminal.

The target eNB sends a handover complete message to a Mobility Management Entity (MME) 206 to inform that the user terminal has a changed cell.

The MME sends a user plane update request message to the serving gateway 208.

The serving gateway switches the downlink data path to the target side and can release any user plane/Transport Network Layer (TNL) resources towards the source eNB.

The serving gateway sends a user plane update response message to the MME.

The MME confirms the handover complete message with the handover complete acknowledge (ack) message.

By sending a release resource, the target eNB informs the source eNB about the success of the handover and triggers the release of resources.

Upon reception of the release resource message, the source eNB can release radio and C-plane related resources associated to the user terminal context.

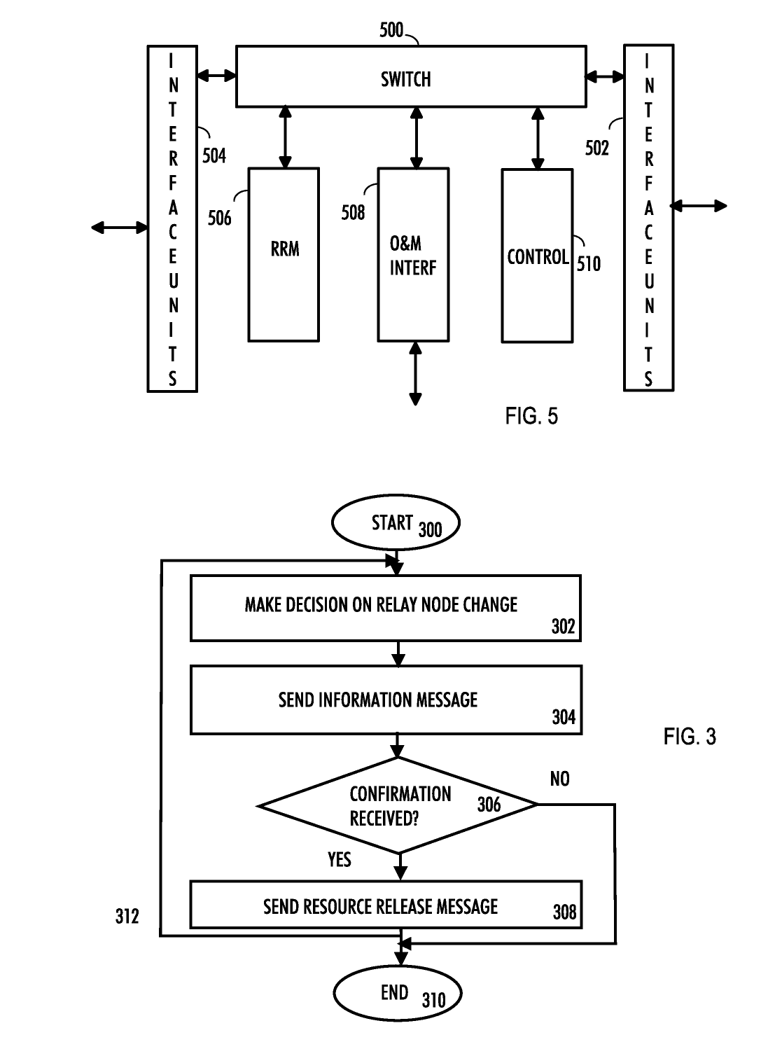

FIG. 3 is a flow chart depicting an embodiment of a simplified method for carrying out a handover. In the embodiment, the MME or serving gateway does not need to be involved when a user terminal changes a relay node controlled by the same eNB, for instance.

The embodiment provides a method facilitating handovers between two relay nodes of the same root eNB. The embodiment allows the system to at least partly “hide” relays from the user terminal's point of view.

Next, an embodiment of the method is explained in further detail by means of FIG. 3. The embodiment starts in block 300.

In block 302, a root node makes a decision to change connection from one relay node to another by a root node. The decision is typically based on measurement reports, which a user device (terminal) sends to the root node. The measurement reports typically include information on a signal-to-noise ratio and power level.

In block 304, the root node sends a message via a source relay node to a user terminal (user device), the message comprising radio access information on a target cell and information on a connection change. This message is typically a cell update message including timing advance (TA) information, dedicated preamble or resource allocation for radio access channel (RACH) preamble and/or Cell-Specific Radio Network Temporary Identity (C-RNTI), if updated, etc.

If a confirmation message from a user device is received (block 306), the root node sends a message to the source relay node for releasing user device resources in the source relay node (block 308).

A timer is typically used for determining waiting time for reception of the confirmation message. By receiving the confirmation message, the root node is informed that the user device is synchronised to a target relay node and has resources allocated for future activities. The synchronisation may not be carried out if timing advance information is available and indicated in the cell update message. Otherwise, TA updating procedure is carried out between the user device and the target relay node by using pre-assigned dedicated resources with RACH.

The confirmation message is usually a cell update confirm message. After receiving it, the root node stops the timer and releases the user device context in the source relay node.

The embodiment ends in block 310. The embodiment is repeatable, and arrow 312 shows one possibility of repetition.

In another embodiment, the root node first configures a target relay node with a user device context. The context may include the user device's C-RNTI, timing advance information and/or dedicated resources, such as a dedicated RACH preamble assigned to the user device for it to be able to synchronise to the target relay node.

In the following, an example of handover messaging is depicted by the means of FIG. 4.

First, a user terminal 200 sends a measurement report message to a root node 400 (eNB) via a source relay node 402. The root node makes a handover decision based on the information received by means of the measurement report message.

Then, possibly, the root node first configures the target relay node 404 with a user device context. The context may include the user device's C-RNTI, timing advance information and/or dedicated resources.

The root node sends a cell update message to the user device 200 via the source relay node. The message includes timing advance (TA) information, dedicated preamble or resource allocation for RACH procedure and/or C-RNTI, if updated, etc. Simultaneously, with sending the message or shortly after that the root node starts a timer guarding the cell-update procedure of the handover.

The user device synchronises itself to the target relay node and allocates resources for future activities. The synchronisation may not be carried out, if timing advance information is available and indicated in the cell update message. Otherwise, TA updating procedure is carried out between the user device and the target relay node by using pre-assigned dedicated resources.

The user device sends a cell update confirm message to the root node via the target relay node. The message may include a Layer 2 status report.

Upon reception of the cell update confirm message, the root node stops the timer.

The root node then releases the user device context in the source relay node and the source relay node releases resources reserved for the user device.

The steps/points, signaling messages and related functions described above in FIG. 2 are in no absolute chronological order, and some of the steps/points may be performed simultaneously or in an order differing from the given one. Other functions can also be executed between the steps/points or within the steps/points and other signaling messages sent between the illustrated messages. Some of the steps/points or part of the steps/points can also be left out or replaced by a corresponding step/point or part of the step/point.

The operations illustrate a procedure that may be implemented in one or more physical or logical entities. The signaling messages are only exemplary and may even comprise several separate messages for transmitting the same information. In addition, the messages may also contain other information.

An embodiment of a communication system implementation of the embodiment described above will now be explained by means of FIG. 1.

A user device 102 makes measurements on the quality of a radio connection and sends the measurement report to a root node 100.

The root node 100 makes a decision to change connection from one relay node to another by a root node. The decision is typically based on measurement reports, which a user device (terminal) sends to the root node. The measurement reports typically include information on a signal-to-noise ratio and power level.

The root node sends a message via a source relay node 106 to the user device, the message comprising radio access information on the target cell and connection change information. This message is typically a cell update message including timing advance (TA) information, dedicated preamble or resource allocation for RACH procedure and/or C-RNTI, if updated, etc.

Simultaneously with sending the message, the root node starts a timer guarding the cell-update procedure of the handover.

The user device synchronises itself to a target relay node 104 and allocates resources for future activities. The synchronisation may not be carried out if timing advance information is available and indicated in the cell update message. Otherwise, a TA updating procedure is carried out between the user device and the target relay node by using pre-assigned dedicated resources with RACH.

The user device sends a cell update confirm message to the root node via the target relay node 104. The message may include a Layer 2 status report.

Upon reception of the cell update confirm message, the root node stops the timer. The root node then releases the user device context in the source relay node and the source relay node releases resources reserved for the user terminal.

Referring to FIG. 5, a simplified block diagram illustrates an example of a logical structure of a relay node.

The relay node of FIG. 5 is an example of an apparatus to which embodiments of the invention are applicable. This example of a relay node may act as a root node, a source node or a target node. It is also possible that the source and target nodes are more simplified in structure than the root node, in which case FIG. 5 depicts a root node.

The relay node is the switching and controlling element of SAE/LTE

(Long Term Evolution (LTE), System Architecture Evolution (SAE)) or other radio access networks. In SAE/LTE, a relay node is called eNB. The core network architecture is typically split into Mobility Management Entity (MME) and a User Plane Entity (UPE) functionalities and 3GPP anchor nodes.

Switching 500 takes care of connections between a core network and a user device. The relay node is connected to other parts of the network via interface units 502, 504.

The functionality of the relay node may be classified into radio resource management 506 and control functions 510. An operation and management interface function 508 serves as a medium for information transfer to and from management functions.

Radio resource management is a group of algorithms for sharing and managing a radio path connection so that the quality and capacity of the connection are adequate. The radio resource management also carries out functions needed for transmitting and receiving radio signals, such as radio frequency and base band functions.

The control functions take care of functions related to set-up, maintenance and release of a radio connection between the radio network element and user devices.

Embodiments of the handover method described above may be carried out in the switching, radio resource management and control functions.

The precise implementation of the relay node is vendor-dependent.

An embodiment provides a computer program embodied on a distribution medium, comprising program instructions which, when loaded into an electronic apparatus, constitute the apparatus, as explained above.

The computer program may be in source code form, object code form, or in some intermediate form, and it may be stored in some sort of carrier or a distribution medium, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital computer or it may be distributed amongst a number of computers.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For a firmware or software, implementation can be through modules of at least one chip set (e.g., procedures, functions, and so on) that perform the functions described herein. The software codes may be stored in a memory unit and executed by the processors. The memory unit may be implemented within the processor or external to the processor, in which case it can be communicatively coupled to the processor via various means as is known in the art. Additionally, components of systems described herein may be rearranged and/or complimented by additional components in order to facilitate achieving the various aspects, etc., described with regard thereto, and they are not limited to the precise configurations set forth in the Figures given, as will be appreciated by one skilled in the art.

It will be obvious to a person skilled in the art that, as technology advances, the inventive concept can be implemented in various ways. The invention and its embodiments are not limited to the examples described above but may vary within the scope of the claims.

1. A method comprising:
making (302) a decision to change connection from one relay node to another by a root node;
sending (304) a message by a root node via a source relay node to a user device, the message comprising radio access information on a target cell and information on a connection change; and
if (306) a confirmation message from the user device is received by the root node,
sending (308) a message by the root node to the source relay node for releasing user device resources in the source relay node.

2. The method of claim 1, further comprising:
configuring by the root node a target relay node with a user device context.

3. The method of claim 1, wherein the message comprising radio access information is a cell update message including at least one of: timing advance information, dedicated radio access channel preamble or cell-specific radio network temporary identity, if updated.

4. The method of claim 1, wherein the message comprising radio access information is a cell update message including information on resource allocation for a random access channel procedure or cell-specific radio network temporary identity, if updated.

5. The method of claim 1, wherein the confirmation message is a cell update confirm message.

6. The method of claim 2, further comprising:
using a timer for determining waiting time for reception of the confirmation message by the root node, and
after the reception of the confirmation message, stopping the timer and sending a message for releasing the user device context in the source relay node.

7. A computer program comprising program instructions which, when loaded into the apparatus, constitute the modules of any preceding claims 1 to 6.

8. An apparatus comprising:
a decision unit configured to make a decision to change connection from one relay node to another; and
a transmission unit configured to send a message via a source relay node to a user device, the message comprising radio access information on a target cell and information on a connection change; and configured to send a message to the source relay node for releasing user device resources in the source relay node.

9. The apparatus of claim 8, further comprising:
a configuration unit configured to configure a target relay node with a user device context.

10. The apparatus of claim 8, wherein the message comprising radio access information is a cell update message including at least one of: timing advance information, dedicated radio access channel preamble or cell-specific radio network temporary identity, if updated.

11. The apparatus of claim 8, wherein the message comprising radio access information is a cell update message including information on resource allocation for a random access channel procedure or cell-specific radio network temporary identity, if updated.

12. The apparatus of claim 8, wherein the confirmation message is a cell update confirm message.

13. The apparatus of claim 9, further comprising:
a timer configured to determine waiting time for reception of the confirmation message by the root node, and
a transmission unit configured to send a message for releasing the user device context in the source relay node.

14. The apparatus of claim 8 or 13, the apparatus being a root node.

15. An apparatus comprising:
means (500, 506, 510) for making a decision to change connection from one relay node to another; and
means (500, 502, 504, 506, 510,) for sending a message via a source relay node to a user device, the message comprising radio access information on a target cell and information on a connection change, and for sending a message to the source relay node for releasing user device resources in the source relay node.

16. The apparatus of claim 15, further comprising:
means (500, 502, 504, 506, 510) for configuring a target relay node with a user device context.

17. The apparatus of claim 15, wherein the message comprising radio access information is a cell update message including at least one of: timing advance information, dedicated radio access channel preamble or cell-specific radio network temporary identity, if updated.

18. The apparatus of claim 15, wherein the message comprising radio access information is a cell update message including information on resource allocation for a random access channel procedure or cell-specific radio network temporary identity, if updated.

19. The apparatus of claim 15, wherein the confirmation message is a cell update confirm message.

20. The apparatus of claim 16, further comprising:
means (506) for determining the waiting time for reception of the confirmation message by the root node, and
means (500, 502, 504, 506, 510) for sending a message for releasing the user device context in the source relay node.

21. The apparatus of claim 15 or 20, the apparatus being a root node.

22. A system comprising:
a root node configured to make a decision to change connection from one relay node to another, and configured to send a message via a source relay node to a user device, the message comprising radio access information on a target cell and information on a connection change, and configured to send a message to the source relay node for releasing user device resources in the source relay node, and
a source relay node and a target relay node configured to convey messages comprising cell update information.

23. The system of claim 22, wherein the message comprising radio access information is a cell update message including at least one of: timing advance information, dedicated radio access channel preamble or cell-specific radio network temporary identity, if updated.

24. The system of claim 22, wherein the message comprising radio access information is a cell update message including information on resource allocation for a random access channel procedure or cell-specific radio network temporary identity, if updated.

25. The system of claim 22, further comprising:
a root node configured to determine waiting time for reception of a confirmation message to the cell update message, and configured to send a message for releasing a user device context in the source relay node.
